(19) United States
(12) Patent Application Publication
(10) Pub. No.: US 2017/0182461 A1
(43) Pub. Date: Jun. 29, 2017

(54) REVERSE OSMOSIS WATER FILTRATION DEVICE WITH WATER STORAGE FUNCTION

(71) Applicant: Xiamen Runner Industrial Corporation, Xiamen (CN)

(72) Inventors: JING-MING LI, Xiamen (CN); JIAN-YONG YAN, Xiamen (CN); DE-SHENG LIANG, Xiamen (CN)

(21) Appl. No.: 15/384,689

(22) Filed: Dec. 20, 2016

(30) Foreign Application Priority Data
Dec. 29, 2015 (CN) 201511002221.3

(51) Int. Cl. B01D 61/12; B01D 61/08; C02F 1/44; B01D 61/02

(52) U.S. Cl. CPC B01D 61/12; B01D 61/025; B01D 61/08; C02F 1/441; B01D 2313/18; B01D 2313/44; C02F 2201/005; C02F 2201/006; C02F 2209/03; C02F 2307/06

(57) ABSTRACT

A reverse osmosis (RO) water filtration device includes a body, a RO cartridge, a first cartridge, a second cartridge and a storage tank all mounted inside the body. Water to be filtered sequentially goes through a water inlet of the RO water filtration device, the first cartridge, the RO cartridge, the storage tank, the second cartridge, and a faucet to get the water filtered. The storage tank provides additional water supply when the pressure between the faucet and RO cartridge is below the water pressure inside the storage tank to increase water volume upon opening a faucet.

### BACKGROUND OF THE INVENTION

1. Field of the Invention

The present invention relates to a reverse osmosis (RO) water filtration device and, more particularly, to an RO water filtration device with water storage function.

2. Description of the Related Art

Conventional reverse osmosis (RO) water filtration devices with small capacity of treated water under 300 G in the current market need to be equipped with an extra storage tank to meet the demand of flow rate when the faucet is opened. Also because the RO water filtration devices are usually mounted inside kitchen cabinets, the additional storage tank is space-taking and inconvenient to use and the water in the storage tank is easily contaminated by bacteria.

### SUMMARY OF THE INVENTION

An objective of the present invention is to provide a RO water filtration device and a method for operating the RO water filtration device.

To achieve the foregoing objective, the RO water filtration device includes a body, a first cartridge, an RO cartridge, a storage tank and a second cartridge.

The body has a water inlet, a filtered water outlet and a waste water outlet formed in a periphery of the body. The filtered water outlet is connected with and communicates with a faucet.

The first cartridge is mounted inside the body and is connected with and communicates with the water inlet through a channel formed inside the body.

The RO cartridge is mounted inside the body and has an inlet, an outlet and an RO waste water outlet.

The inlet is connected with and communicates with the first cartridge through a channel formed inside the body. A pump is mounted to the channel between the RO cartridge and the first cartridge.

The RO waste water outlet is connected and communicates with the waste water outlet through a channel formed inside the body.

The storage tank is mounted inside the body, is connected with and communicates with the outlet of the RO cartridge through a channel formed inside the body, and has a liner mounted on an inner wall of the storage tank. The liner is made of a resilient material.

The second cartridge is mounted inside the body, and is connected with and communicates with the filtered water outlet and the storage tank respectively through two channels formed inside the body. A high-pressure switch is mounted to the channel between the second cartridge and the storage tank to control operation of the pump.

When the faucet is closed, the pump is operated to fill the storage tank with filtered water until a water pressure of filtered water inside the storage tank sensed by the high-pressure switch reaches a water pressure threshold, and when the faucet is open and a water pressure between the storage tank and the second cartridge sensed by the high-pressure switch drops below the water pressure threshold, the filtered water inside the storage tank pushed out by the liner of the storage tank and filtered water outputted from the RO cartridge flows to the faucet.

To achieve the foregoing objective, the method for operating an RO water filtration device includes steps of:
closing the faucet;
operating the pump at an output water pressure;
stopping the pump from operating when a water pressure between the RO cartridge and the faucet reaches a water pressure threshold, wherein the water pressure threshold is lower than the output water pressure, and the storage tank is filled with filtered water at the water pressure threshold and the liner of the storage tank is squeezed by the filtered water inside the storage tank;
opening the faucet for a water pressure between the RO cartridge and the faucet to drop; and
starting the pump when the water pressure between the RO cartridge and the faucet is below the water pressure threshold, wherein the filtered water in the storage tank pushed out of the storage tank by the liner and the filtered water outputted from the RO cartridge flow to the faucet.

When compared to conventional techniques, the present invention has the following advantages that because the storage tank and all the cartridges are all mounted inside the body, the issues arising from insufficient space and aesthetic concern can be tackled, production cost can be reduced, and bacteria contamination in the storage tank can be resolved.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of an RO water filtration device with water storage function in accordance with the present invention;

FIG. 2 is a schematic top view of the RO water filtration device in FIG. 1; and

FIG. 3 is a cross-sectional view of a storage tank of the RO water filtration device in FIG. 1.

### DETAILED DESCRIPTION OF THE INVENTION

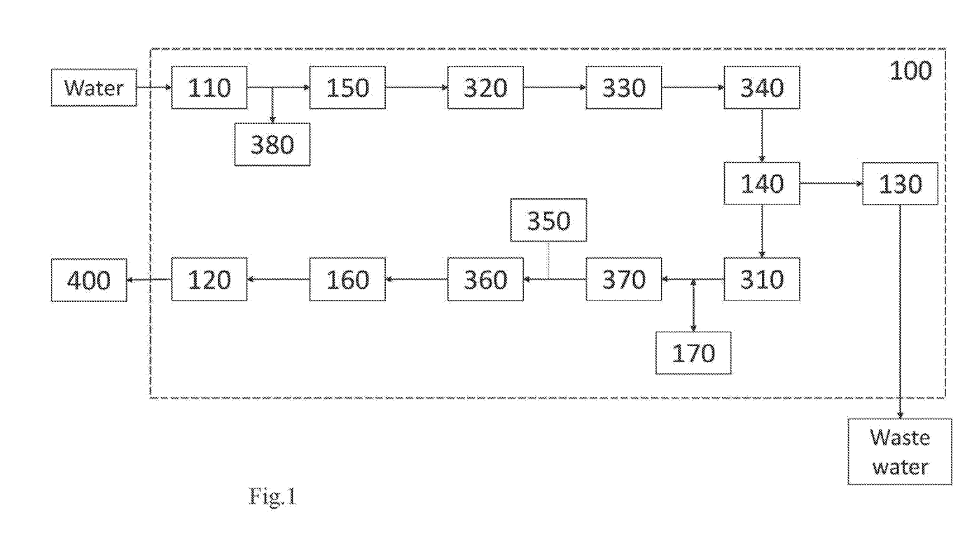

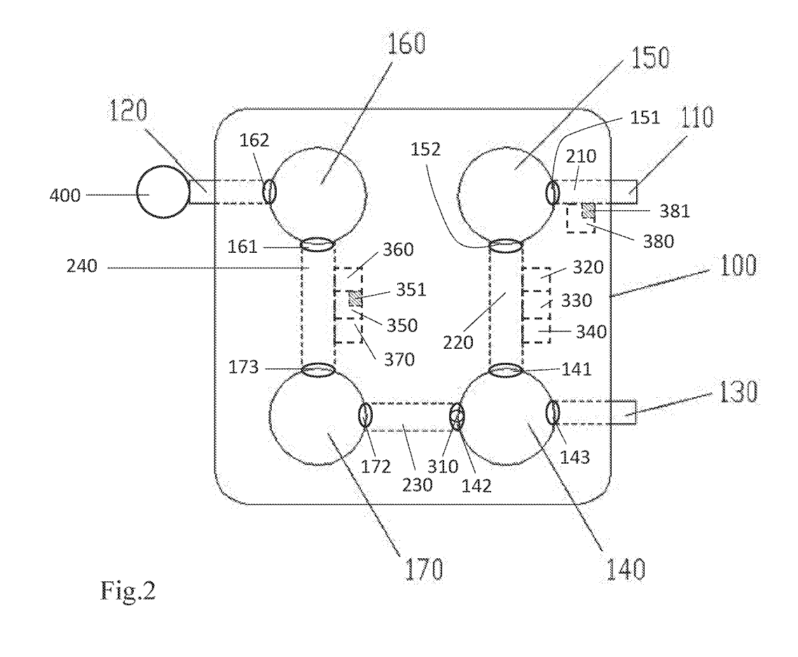

With reference to FIGS. 1 and 2, an RO water filtration device in accordance with the present invention includes a body 100, a RO filter cartridge 140, a first cartridge 150, a second cartridge 160 and a storage tank 170.

The body 100 has a water inlet 110, a filtered water outlet 120 and a waste water outlet 130. The water inlet 110 and the waste water outlet 130 are mounted in a first lateral portion of the RO water filtration device 100, and the filtered water outlet 120 is mounted in a second lateral portion opposite to the first lateral portion.

The first cartridge 150 is mounted inside the body 100 and has a first inlet 151 and a first outlet 152. The first inlet 151 communicates with the water inlet 110 through a first channel 210 formed inside the body 100 and connected between and communicating with the first inlet 151 and the water inlet. A low-pressure switch 380 is mounted to the first channel 210. The first outlet 152 communicates with the RO cartridge 140 through a second channel 220 formed inside the body 100 and connected between and communicating with the first cartridge 150 and the RO cartridge 140. A solenoid valve 320, a water TDS (total dissolved solids) transducer 330 and a pump 340 are mounted to the second channel 210, and the pump 340 is electrical connected with the low-pressure switch 380. The solenoid valve 320 is to control water flows direction and flow speed. The water TDS transducer 330 is to detect any minerals, salts, metals, cations or anions dissolved in water.

The low-pressure switch 380 has a controller 381, and the low-pressure switch 380 detects a water pressure into the first channel 210. When the water pressure is low or no pressure at all, the controller 381 sends a signal to the pump 340 to stop the pump 340 from working.

The RO cartridge 140 is mounted inside the body 100 and has an inlet 141, an outlet 142 and a RO waste water outlet 143. The inlet 141 communicates with the first cartridge 150 through the second channel 220. The outlet 142 communicates with the storage tank 170 through a third channel 230. A check valve 310 is mounted into the outlet 142. The RO waste water outlet 143 communicates with the waste water outlet 130 through a fifth channel 250 formed inside the body 100 and connected between and communicating with the RO waste water outlet 143 and the waste water outlet 130, and water containing impurities flows out of the waste water outlet 130 through the RO waste water outlet 143 and the fifth channel 250 sequentially.

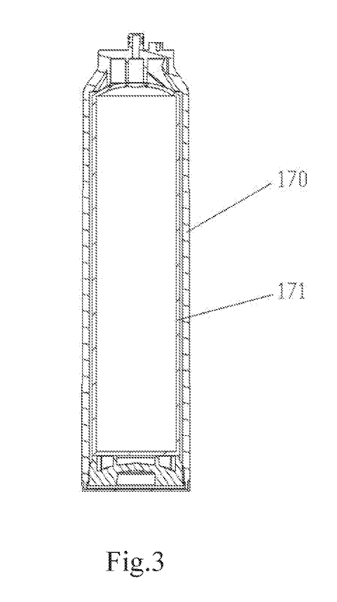

The storage tank 170 is mounted inside the body 100 and has a storage tank inlet 172 and a storage tank outlet 173. The storage tank inlet 172 communicates with the RO cartridge 140 through a third channel 230 formed in the body 100 and connected between the storage tank 170 and the RO cartridge 140. The storage tank outlet 173 is connected with and communicates with a fourth channel 240 formed in the body 100 and connected between the storage tank 170 and a second cartridge 160. With reference to FIG. 3, a liner 171 is mounted on an inner wall of the storage tank 170 and is made of a resilient material.

The second cartridge 160 is mounted inside the body 100 and has a second inlet 161 and a second outlet 162. The second inlet 161 is connected with and communicates with the fourth channel 240. The second outlet 162 is connected with and communicates with the filtered water outlet 120 through the fourth channel 240.

A flowmeter 370, a high-pressure switch 350, and a filtered water TDS transducer 360 are mounted to the fourth channel 240. The filtered water TDS transducer 360 is to detect any minerals, salts, metals, cations or anions dissolved in water. A controller 351 is mounted into the high-pressure switch 350, and the high-pressure switch 350 is electrical connected with the pump 340. The high-pressure switch 350 senses the water pressure in the storage tank 170 and is switched to be open or closed by the water pressure in the storage tank 170, and respectively sends a start signal and a stop signal to the controller 351 when the water pressure in the storage tank 170 is below 40 psi and when the water pressure in the storage tank 170 reaches 40 psi.

The filtered water outlet 120 communicates with the second outlet 162 of the second cartridge 160 through a sixth channel 260 formed inside the body 100 and connected between and communicating with the filtered water outlet 120 and the second outlet 160, and is connected with and communicates with a faucet 400.

Operation of the RO water filtration device 100 is described as follows. Water to be filtered enters the water inlet 110 of the RO water filtration device 100, and flows in the first cartridge 150 through the first channel 210. Water filtered by the first cartridge 150 flows out of the first cartridge 150 through the first outlet 152, then flows through the second channel 220, the solenoid valve 320, the TDS transducer 330 and the pump 340. After the pressure of water in the pump 340 is boosted to be stable, water in the pump 340 flows out and then enters the RO filter cartridge 140 through the inlet 141 of the RO filter cartridge 140. Impurities in water pass through the osmosis membrane and are removed and filtered water flows out of the outlet 142. Meanwhile, water containing impurities flows to the waste water outlet 130 of the RO water filtration device 100 through the RO waste water outlet 143 and the fifth channel 250. Filtered water flow from the outlet 142 flows through the third channel 230 and then enters the storage tank 170 through the storage tank inlet 172. A portion of filtered water is stored in the storage tank 170, the remaining portion of filtered water flows out of the storage tank 170 through the storage tank outlet 173, and then enters the second cartridge 160 through the fourth channel 240. Filtered water enters the second cartridge 160 through the second inlet 161 and reacts with the second cartridge 160, and water flowing out of the second outlet 162 further flows to the faucet 400.

In normal use, water pressure between the pump 340 and the RO cartridge 140 is 70 psi. After the faucet 400 is closed, water is detained inside the RO water filtration device 100, and the pump 340 is started operating to pump out the water in the pump 340. Filtered water flowing out of the RO cartridge 140 flows in the storage tank 170 to fill the storage tank 170 and squeeze the liner 171. After the storage tank 170 is fully filled, the water pressure acted on the liner 171 of the storage tank 170 is 40 psi and filtered water further enters the fourth channel 240. When the water pressure of the fourth channel 240 detected by the high-pressure switch 350 reaches 40 psi, the controller 351 receives the stop signal from the high-pressure switch 350 and sends a signal to the pump 340 to stop the pump 340 from working.

When the faucet 400 is opened, filtered water flows out of the faucet 400, water pressure between the RO cartridge 140 and the faucet 400 drops. Once the water pressure of the fourth channel 240 sensed by the high-pressure switch 350 drops below 40 psi, the controller 351 sends another signal to the pump 340 for the pump 340 to start working. Further, as the pressure acted on the liner 171 of the storage tank 170 is 40 psi, which is higher than the pressure in the fourth channel 240, the liner 171 releases its elastic force to push the filtered water out of the storage tank 170. Both filtered water from the storage tank 170 and filtered water outputted from the outlet 142 flows to the faucet 400 to increase water flow out of the faucet 400.

As the storage tank 170 and all the cartridges 140, 150, 160 are all mounted inside the body 100, the issues arising from insufficient space and aesthetic concern can be tackled, production cost can be reduced, and bacteria contamination in the storage tank can be resolved.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A reverse osmosis (RO) water filtration device with water storage function, comprising:
a body having a water inlet, a filtered water outlet and a waste water outlet formed in a periphery of the body, wherein the filtered water outlet is connected with and communicates with a faucet;
a first cartridge mounted inside the body and connected with and communicating with the water inlet through a channel formed inside the body;
an RO cartridge mounted inside the body and having:
an inlet connected with and communicating with the first cartridge through a channel formed inside the body, wherein a pump is mounted to the channel between the RO cartridge and the first cartridge;
an outlet; and
an RO waste water outlet connected with and communicating with the waste water outlet through a channel formed inside the body;
a storage tank mounted inside the body, connected with and communicating with the outlet of the RO cartridge through a channel formed inside the body, and having a liner mounted on an inner wall of the storage tank, wherein the liner is made of a resilient material; and
a second cartridge mounted inside the body, and connected with and communicating with the filtered water outlet and the storage tank respectively through two channels formed inside the body, wherein a high-pressure switch is mounted to the channel between the second cartridge and the storage tank to control operation of the pump;
wherein when the faucet is closed, the pump is operated to fill the storage tank with filtered water until a water pressure of filtered water inside the storage tank sensed by the high-pressure switch reaches a water pressure threshold, and when the faucet is open and a water pressure between the storage tank and the second cartridge sensed by the high-pressure switch drops below the water pressure threshold, the filtered water inside the storage tank pushed out by the liner of the storage tank and filtered water outputted from the RO cartridge flows to the faucet.

2. The RO water filtration device as claimed in claim 1, wherein a check valve is mounted into the outlet of the RO cartridge, the water pressure threshold being drops below 40 psi.

3. The RO water filtration device as claimed in claim 1, wherein a check valve is mounted into the outlet of the RO cartridge, and a solenoid valve and a water TDS (total dissolved solids) transducer are mounted to the channel between the RO cartridge and the first cartridge,

4. The RO water filtration device as claimed in claim 3, wherein a filtered water TDS transducer and a flowmeter are mounted to a channel formed inside the body, and connected between and communicating with the storage tank and the second cartridge.

5. The RO water filtration device as claimed in claim 1, wherein a low-pressure switch is mounted to a channel connected between and communicating with the first cartridge and the water inlet of the body.

6. A method for operating a reverse osmosis (RO) water filtration device as claimed in claim 4, comprising steps of:
closing the faucet;
operating the pump at an output water pressure;
stopping the pump from operating when a water pressure between the RO cartridge and the faucet reaches a water pressure threshold, wherein the water pressure threshold is lower than the output water pressure, and the storage tank is filled with filtered water at the water pressure threshold and the liner of the storage tank is squeezed by the filtered water inside the storage tank;
opening the faucet for a water pressure between the RO cartridge and the faucet to drop; and
starting the pump when the water pressure between the RO cartridge and the faucet drops below the water pressure threshold, wherein the filtered water in the storage tank pushed out of the storage tank by the liner and the filtered water outputted from the RO cartridge flow to the faucet.

7. The RO water filtration device as claimed in claim 6, wherein a check valve is mounted into the outlet of the RO cartridge, the water pressure threshold being drops below 40 psi.
